(19) United States
(12) Patent Application Publication
(10) Pub. No.: US 2026/0169171 A1
(43) Pub. Date: Jun. 18, 2026

(54) APPARATUS AND METHOD FOR SCHEDULING TRANSMISSION OF SATELLITE NAVIGATION CORRECTION MESSAGES USING MULTIPLE SATELLITES

(71) Applicant: ELECTRONICS AND TELECOMMUNICATIONS RESEARCH INSTITUTE, Daejeon (KR)

(72) Inventors: In Jun KIM, Daejeon (KR); Tae Hee KIM, Daejeon (KR); Soo Jeon LEE, Daejeon (KR); Yoo La HWANG, Daejeon (KR)

(73) Assignee: ELECTRONICS AND TELECOMMUNICATIONS RESEARCH INSTITUTE, Daejeon (KR)

(21) Appl. No.: 19/417,043

(22) Filed: Dec. 11, 2025

(30) Foreign Application Priority Data
Dec. 12, 2024 (KR) 10-2024-0185030

(51) Int. Cl. G01S 19/07

(52) U.S. Cl. CPC G01S 19/07

(57) ABSTRACT

Provided is an apparatus and method for scheduling transmission of satellite navigation correction messages using multiple satellites, the apparatus including: a communication unit; and a processor that receives position prediction information of each satellite from a satellite control system through the communication unit, calculates a line of sight and an elevation angle of each of the satellites based on the position prediction information, and generates message transmission schedule information for transmitting a satellite navigation correction message by considering the calculated line of sight and the calculated elevation angle.

### CROSS-REFERENCE TO RELATED APPLICATION

This application claims priority to and the benefit of Korean Patent Application No. 10-2024-0185030, filed on Dec. 12, 2024, the disclosure of which is incorporated herein by reference in its entirety.

### BACKGROUND

### 1. Field of the Invention

The present invention relates to an apparatus and method for scheduling transmission of satellite navigation correction messages using multiple satellites.

### 2. Discussion of Related Art

Satellite navigation services, which provide the location of a user using navigation signals from satellite navigation systems, are widely used. However, error factors come into play while navigation signals are transmitted to users, resulting in reduced position accuracy. To compensate for this and improve position accuracy, correction services such as wide-area correction systems and regional correction systems are provided via satellites or terrestrial communication networks. In particular, satellite-based augmentation systems (SBASs) or regional satellite navigation systems are mainly used as wide-area correction systems.

Conventional wide-area correction systems using satellites adopt a method of periodically transmitting correction messages to users using geostationary satellite communication services. In this case, different types of messages are defined according to error factors and transmitted sequentially. Users may only eliminate error factors after receiving all messages. Therefore, users may not correct their position until all types of messages are received and may only calculate the first corrected position after receiving all messages. Therefore, for users to rapidly calculate corrected positions, there is a method of stably and rapidly transmitting multiple types of messages to users using satellites.

### SUMMARY OF THE INVENTION

The present invention is directed to providing an apparatus and method for efficiently delivering correction information to a user such that position accuracy may be improved using the correction information in a satellite navigation service that determines the position of the user using satellites.

According to an aspect of the present invention, there is provided an apparatus for scheduling transmission of satellite navigation correction messages using multiple satellites, which includes: a communication unit; and a processor that receives position prediction information of each satellite from a satellite control system through the communication unit, calculates a line of sight and an elevation angle of each of the satellites based on the position prediction information, and generates message transmission schedule information for transmitting a satellite navigation correction message by considering the calculated line of sight and the calculated elevation angle.

The processor calculates a line of sight of each of the satellites based on the position prediction information and position information of an uplink station and calculates an elevation angle of each of the satellites based on the position prediction information and service reference position information.

The processor calculates an elevation angle of each satellite for which a line of sight is ensured from the uplink station, based on the calculated line of sight of each of the satellites and generates the message transmission schedule information based on the calculated elevation angle.

The satellite control system may generate the position prediction information that estimates in-orbit positional changes of each of the satellites using data required for orbit prediction of each of the satellites among telemetry data transmitted by each of the satellites and transmit the position prediction information to the processor through the communication unit.

The processor may receive state of health (SOH) information of each of the satellites from the satellite control system through the communication unit and generate the message transmission schedule information by further considering the SOH information together with the calculated line of sight and the calculated elevation angle.

The processor may select a satellite group having a normal SOH based on the SOH information and generate the message transmission schedule information by comparing the calculated elevation angles of satellites for which lines of sight are ensured among the selected satellite group.

The processor may select and sort a group of visible satellites in order of high elevation angle among the satellites for which lines of sight are ensured according to a result of the comparison; divides message scheduling sections based on a time point at which N (N is a natural number of 2 or more) satellites having the highest elevation angles in the group of the visible satellites change; and generate the message transmission schedule information by dividing messages and assigning the divided messages to the satellites for each of the divided message scheduling sections.

The processor may divide single block messages and multiple block messages and assign the divided single block messages and the divided multiple block messages to each of N inclined geosynchronous orbit (IGSO) satellites having the highest elevation angles and divide single block messages and assigns the divided single block messages to IGSO satellites excluding the N IGSO satellites.

The processor may divide single block messages, assign the divided single block messages to M (M is a natural number of 1 or more) geostationary earth orbit (GEO) satellites having the highest elevation angle, divide multiple block messages, and assign the divided multiple block messages to GEO satellites excluding the M GEO satellites.

The satellite control system may generate the SOH information on determining a health status of each of the satellites using data required for determining a health status of each of the satellites among telemetry data transmitted by each of the satellites and transmit the SOH information to the processor through the communication unit.

According to an aspect of the present invention, there is provided a method of scheduling transmission of satellite navigation correction messages using multiple satellites, which includes: receiving, by a processor, position prediction information of each satellite from a satellite control system through a communication unit; calculating, by the processor, a line of sight and an elevation angle of each of the satellites based on the position prediction information; and generating, by the processor, message transmission schedule information for transmitting a satellite navigation correction message by considering the calculated line of sight and the calculated elevation angle.

The calculating of the line of sight and the elevation angle of each satellite may include calculating a line of sight of each of the satellites based on the position prediction information and position information of an uplink station and calculating an elevation angle of each of the satellites based on the position prediction information and service reference position information.

The calculating of the elevation angle of each of the satellites may include calculating an elevation angle of each satellite for which a line of sight is ensured from the uplink station, based on the calculated line of sight of each of the satellites and generating the message transmission schedule information based on the calculated elevation angle.

The method may further include generating the position prediction information on estimation of in-orbit positional changes of each of the satellites using data required for orbit prediction of each of the satellites among telemetry data transmitted by each of the satellites and transmitting the position prediction information to the processor through the communication unit.

The method may further include receiving, by the processor, SOH information of each of the satellites from a satellite control system through the communication unit, wherein the generating of the message transmission schedule information may include generating the message transmission schedule information by further considering the SOH information together with the calculated line of sight and the calculated elevation angle.

The generating of the message transmission schedule information may include selecting a satellite group having a normal SOH based on the SOH information and generating the message transmission schedule information by comparing the calculated elevation angles of satellites for which lines of sight are ensured among the selected satellite group.

The generating of the message transmission schedule information by comparing the calculated elevation angles may include: selecting and sorting a group of visible satellites in order of high elevation angle among the satellites for which line of sight are ensured according to a result of the comparison; dividing message scheduling sections based on a time point at which N (N is a natural number of 2 or more) satellites having the highest elevation angles in the group of the visible satellites change, and generating the message transmission schedule information by dividing messages and assigning the divided messages to the satellites for each of the divided message scheduling sections.

The generating of the message transmission schedule information by dividing messages and assigning the divided messages to the satellites may include dividing single block messages and multiple block messages, assigning the divided single block messages and the divided multiple block messages to each of N IGSO satellites having the highest elevation angles, dividing single block messages, and assigning the divided single block messages to IGSO satellites excluding the N IGSO satellites.

The generating of the message transmission schedule information by dividing messages and assigning the divided messages to the satellites may include dividing single block messages and assigning the divided single block messages to M (M is a natural number of 1 or more) GEO satellites having the highest elevation angles and dividing multiple block messages and assigning the divided multiple block messages to GEO satellites excluding the M GEO satellites.

The method may further include generating, by the satellite control system, the SOH information on determining a health status of each of the satellites using data required for determining a health status of each of the satellites among telemetry data transmitted by each of the satellites and transmitting, by the satellite control system, the SOH information to the processor through the communication unit.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a block diagram illustrating an apparatus for scheduling transmission of satellite navigation correction messages using multiple satellites;

FIG. 2 is a block diagram illustrating a detailed configuration of a processor shown in FIG. 1;

FIG. 3 shows a method of determining satellite lines of sight and elevation angles based on different reference points according to the present invention;

FIG. 4 is a diagram illustrating an embodiment of a multiple satellite correction message block provided according to the present invention;

FIGS. 5 and 6 are flowcharts for describing a method of scheduling transmission of satellite navigation correction messages using multiple satellites according to an embodiment of the present invention;

FIG. 7 is a diagram illustrating an embodiment in which correction message scheduling sections are divided based on changes in satellites having high elevation angles according to the present invention;

FIG. 8 is a diagram illustrating an embodiment in which message types are assigned over time through message scheduling for each satellite for correction message services using multiple satellites according to the present invention; and

FIG. 9 is a diagram illustrating an embodiment of message schedules that change for each satellite when the scheduling section changes due to a change in satellites having high elevation angles according to the present invention.

### DETAILED DESCRIPTION OF EXEMPLARY EMBODIMENTS

Hereinafter, embodiments according to the present invention will be described. In this process, the thickness of each line or the size of each component shown in the drawings may be exaggerated for the purposes of clarity and convenience. Although terms used herein are selected from among general terms that are currently widely used in consideration of functions in the exemplary embodiments, these may be changed according to intentions or customs of those skilled in the art or the advent of new technology.

In the following description, embodiments of the present invention will be described in detail with reference to the accompanying drawings so that those of ordinary skill in the art can easily implement the present invention. However, the present invention may be implemented in various different forms and is not limited to the embodiments described herein. In the drawings, parts irrelevant to the description are omitted in order to clearly describe the present invention, and similar reference numerals are attached to similar parts throughout the specification.

Throughout the specification, when a part “includes” a certain component, it does not mean that other components are excluded and other components or one or more other features may be further included unless specifically stated to the contrary.

The implementations described herein may be implemented in, for example, a method or process, an apparatus, a software program, a data stream, or a signal. Even when only discussed in the context of a single form of implementation (for example, discussed only as a method), the implementation of discussed features may also be implemented in other forms (for example, an apparatus or program). An apparatus may also be implemented in appropriate hardware, software, and firmware. The methods may be implemented in, for example, an apparatus such as a processor, which is a general term for a processing device, such as a computer, a microprocessor, an integrated circuit, or a programmable logic device.

Hereinafter, exemplary embodiments of the present invention will be described in detail with reference to the accompanying drawings.

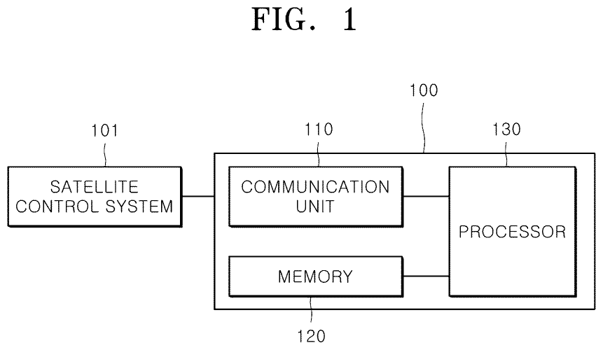

FIG. 1 is a block diagram illustrating an apparatus for scheduling transmission of satellite navigation correction messages using multiple satellites.

Referring to FIG. 1, an apparatus 100 for scheduling transmission of satellite navigation correction messages using multiple satellites according to an embodiment of the present invention may include a communication unit 110, a memory 120, and a processor 130.

The communication unit 110 may receive position prediction information of each satellite from a satellite control system 101. In addition, the communication unit 110 may receive state of health (SOH) information of each satellite from the satellite control system 101.

The communication unit 110 may perform wired and wireless communication with other devices or networks. To this end, the communication unit 110 may include a communication module supporting at least one of various wired and wireless communication methods. For example, the communication module may be implemented in the form of a chipset.

The wireless communication supported by the communication unit 110 may include, for example, wireless fidelity (Wi-Fi), Wi-Fi Direct, Bluetooth, ultra wideband (UWB), or near field communication (NFC). In addition, the wired communication supported by the communication unit 110 may include, for example, Ethernet networks through TCP/IP.

The memory 120 may store information received through the communication unit 110, for example, position prediction information of each satellite, SOH information, and the like. In addition, the memory 120 may store information processed by the processor 130.

The memory 120 may store at least one instruction executed by the processor 130. The memory 120 may be implemented as a read-only memory (ROM) (for example, an electrically erasable programmable read-only memory (EEPROM)), a random access memory (RAM), and the like included in the processor 130, or may be implemented as a memory separate from the processor 130.

In this case, the memory 120 may be implemented in the form of a memory embedded in the apparatus 100 for scheduling transmission of satellite navigation correction messages using multiple satellites, or may be implemented in the form of a memory detachable from the apparatus 100 for scheduling transmission of satellite navigation correction messages using multiple satellites, according to the purpose of data storage.

For example, data for driving the apparatus 100 for scheduling transmission of satellite navigation correction messages using multiple satellites may be stored in the memory 120 embedded in the apparatus 100 for scheduling transmission of satellite navigation correction messages using multiple satellites, and data for expansion functions of the apparatus 100 for scheduling transmission of satellite navigation correction messages using multiple satellites may be stored in the memory 120 detachable from the apparatus 100 for scheduling transmission of satellite navigation correction messages using multiple satellites.

Here, the memory 120 embedded in the apparatus 100 for scheduling transmission of satellite navigation correction messages using multiple satellites may be implemented as at least one of a volatile memory (such as a dynamic random access memory (DRAM), a static random access memory (SRAM), or a synchronous dynamic random access memory (SDRAM)), or a non-volatile memory (such as one-time programmable read-only memory (OTPROM), a programmable read-only memory (PROM), an erasable programmable read-only memory (EPROM), an electrically erasable programmable read-only memory (EEPROM), a mask read-only memory (mask ROM), a flash read-only memory (flash ROM), a flash memory (such as NAND flash or NOR flash), a hard disk drive (HDD), or a solid state drive (SSD)).

In addition, the memory 120 detachable from or attachable to the apparatus 100 for scheduling transmission of satellite navigation correction messages using multiple satellites may be implemented in forms such as memory cards (for example, a compact flash (CF), a secure digital (SD), a micro secure digital (Micro-SD), a mini secure digital (Mini-SD), an extreme digital (xD), or a multi-media card (MMC)), or an external memory connectable to Universal Serial Bus (USB) ports (for example, USB memory), etc.

The processor 130 may receive position prediction information of each satellite from the satellite control system 101 through the communication unit 110.

Specifically, the satellite control system 101 may generate the position prediction information on estimation of in-orbit positional changes of each satellite using data required for orbit prediction of each satellite among telemetry data transmitted by each satellite. The satellite control system 101 may transmit the position prediction information to the processor 130 through the communication unit 110. Accordingly, the processor 130 may receive the position prediction information from the satellite control system 101 through the communication unit 110.

The processor 130 may calculate a line of sight and an elevation angle of each satellite based on the position prediction information received through the communication unit 110. That is, the processor 130 may calculate the line of sight of each satellite based on the position prediction information and position information of an uplink station. The processor 130 may calculate the elevation angle of each satellite based on the position prediction information and service reference position information.

The processor 130 may generate message transmission schedule information for transmitting satellite navigation correction messages in consideration of the calculated line of sight and the calculated elevation angle. In this case, the processor 130 may calculate elevation angles for satellites for which lines of sight are ensured from the uplink station based on the calculated line of sight of each satellite, and generate the message transmission schedule information based on the calculated elevation angles.

Meanwhile, the processor 130 may receive SOH information of each satellite from the satellite control system 101 through the communication unit 110.

Specifically, the satellite control system 101 may generate SOH information on determination of the health status of each satellite using data required for determining a health status of each satellite among telemetry data transmitted by each satellite, and transmit the generated SOH information to the processor 130. Accordingly, the processor 130 may receive the SOH information through the communication unit 110.

The processor 130 may generate the message transmission schedule information by further considering the SOH information together with the previously calculated line of sight and elevation angle. That is, the processor 130 may select a satellite group having a normal SOH based on the SOH information and generate the message transmission schedule information by comparing the calculated elevation angles of satellites for which a line of sight is ensured among the selected satellite group.

The processor 130 may select and sort a group of visible satellites in order of high elevation angle among the satellites for which lines of sight are ensured according to a result of the comparison, divide message scheduling sections based on a time point at which N (N is a natural number of 2 or more) satellites having the highest elevation angles among the group of visible satellites change, and generate the message transmission schedule information by dividing messages for each of the divided message scheduling sections and assigning the divided messages to each satellite.

In this case, the processor 130 may divide single and multiple block messages and assign the divided single and multiple block messages to each of N inclined geosynchronous orbit (IGSO) satellites having the highest elevation angles, and divide single block messages and assign the divided single block messages to IGSO satellites excluding the N IGSO satellites. Alternatively, the processor 130 may divide single block messages and assign the divided single block messages to M (M is a natural number of 1 or more) geostationary earth orbit (GEO) satellites having the highest elevation angles, and divide multiple block messages and assign the multiple block messages to GEO satellites excluding the M GEO satellites.

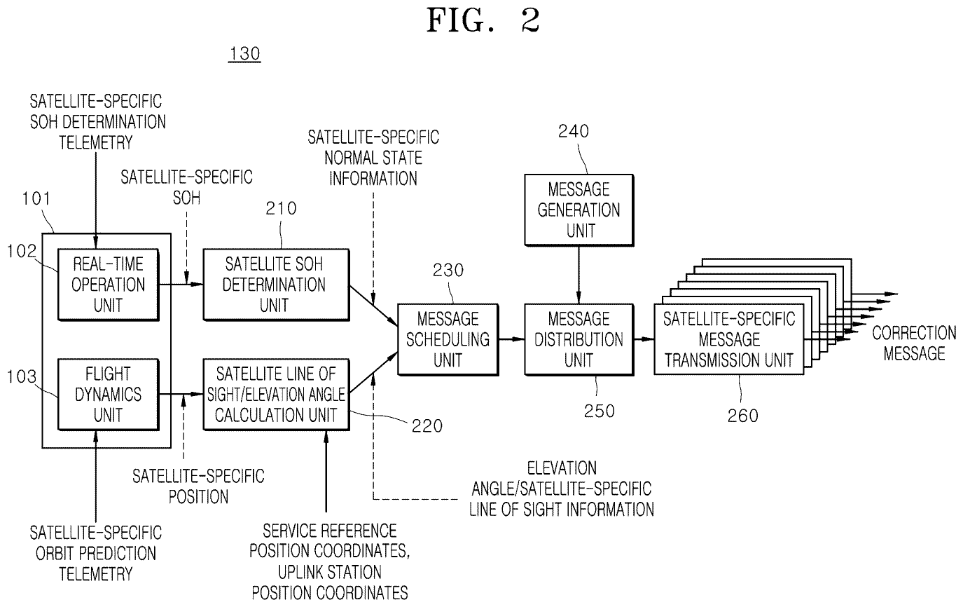

FIG. 2 is a block diagram illustrating a detailed configuration of a processor shown in FIG. 1.

Referring to FIG. 2, the processor 130 may include a satellite SOH determination unit 210, a satellite line-of-sight/elevation angle calculation unit 220, a message scheduling unit 230, a message generation unit 240, a message distribution unit 250, and a satellite-specific message transmission unit 260.

Here, the satellite SOH determination unit 210, the satellite line-of-sight/elevation angle calculation unit 220, the message scheduling unit 230, the message generation unit 240, the message distribution unit 250, and the satellite-specific message transmission unit 260 may be implemented as separate devices in hardware, or may be implemented in the form of logic within the processor 130.

For reference, the satellite control system 101 may include a real-time operation unit 102 and a flight dynamics unit 103. The real-time operation unit 102 and the flight dynamics unit 103 are devices that generate measurement information required for message scheduling using telemetry data acquired from satellites.

Here, the real-time operation unit 102 is one subsystem constituting the satellite control system 101 and serves to extract telemetry for determining the health status of satellites among the telemetry data transmitted by multiple satellites and delivering the extracted telemetry to the satellite SOH determination unit 210.

The flight dynamics unit 103 is also one of the subsystems constituting the satellite control system 101, and serves to generate orbit prediction data on estimation of in-orbit positional changes of each satellite using telemetry required for orbit prediction among the telemetry data transmitted by multiple satellites and delivering the generated orbit prediction data to the satellite line-of-sight/elevation angle calculation unit 220.

The satellite SOH determination unit 210 and the satellite line-of-sight/elevation angle calculation unit 220 are devices that generate input information for use in message scheduling using acquired measurement information.

The satellite SOH determination unit 210 delivers, to the message scheduling unit 230, a result of determining a normal state of each satellite using telemetry for determining the health state of each of the multiple satellites. Normal state information of each satellite is used to determine whether the satellite is used when performing scheduling in which correction messages with various message types are assigned to each satellite.

The satellite line-of-sight/elevation angle calculation unit 220 has a function of checking whether a line of sight is ensured between the uplink station and each of the multiple satellites according to position changes of each of the multiple satellites over time, and a function of calculating a change in an elevation angle between the service reference position and each of the multiple satellites according to position changes of each of the multiple satellites over time.

Here, the position of the uplink station is the position of an antenna that transmits messages to satellites, and the service reference position is a reference position in a main service area in which correction messages transmitted by satellites may be received with as little signal interference or blockage as possible.

For example, the satellite line-of-sight/elevation angle calculation unit 220 may set a dense urban area with high-rise buildings as the service reference position and may assign message schedules such that correction messages are provided based on satellites with high elevation angles, in view of the correcting area, thereby rapidly and continuously calculating corrected positions even in urban areas.

The message scheduling unit 230 is a device that generates message transmission schedules using input information. The message scheduling unit 230 generates message transmission schedule information on determining how to transmit messages with various message types over time to each of the multiple satellites based on elevation angles calculated for satellites whose SOH is normal and whose line of sight is ensured from the uplink station.

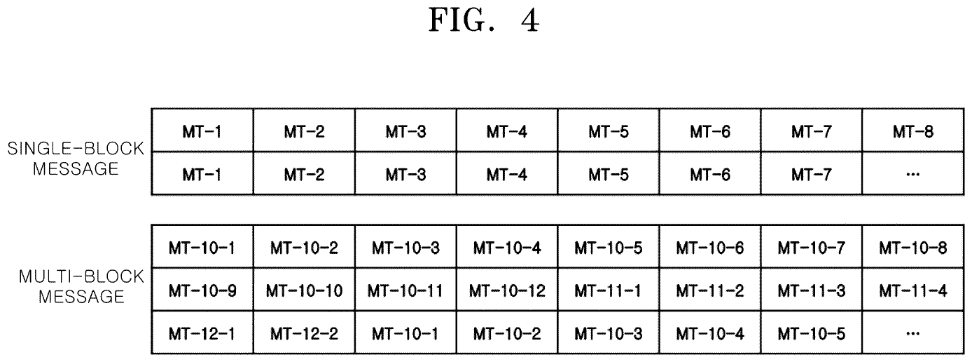

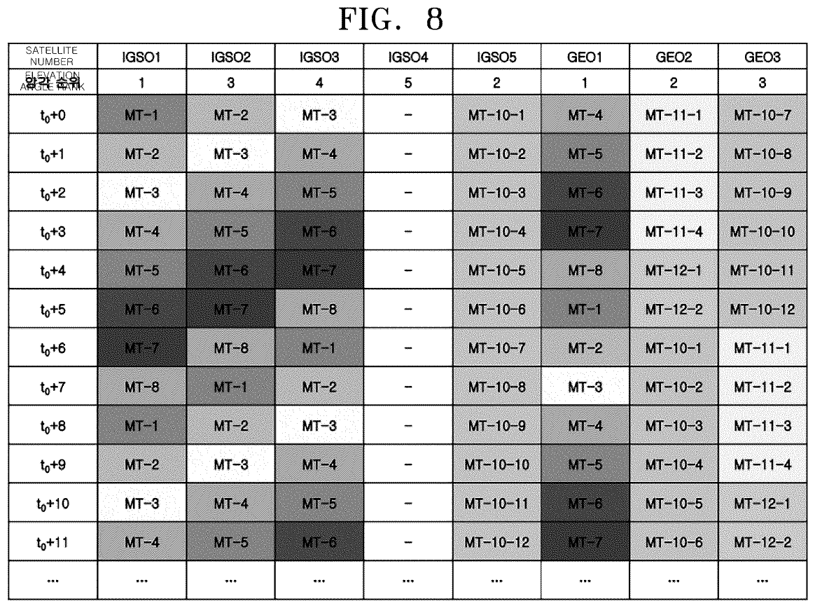

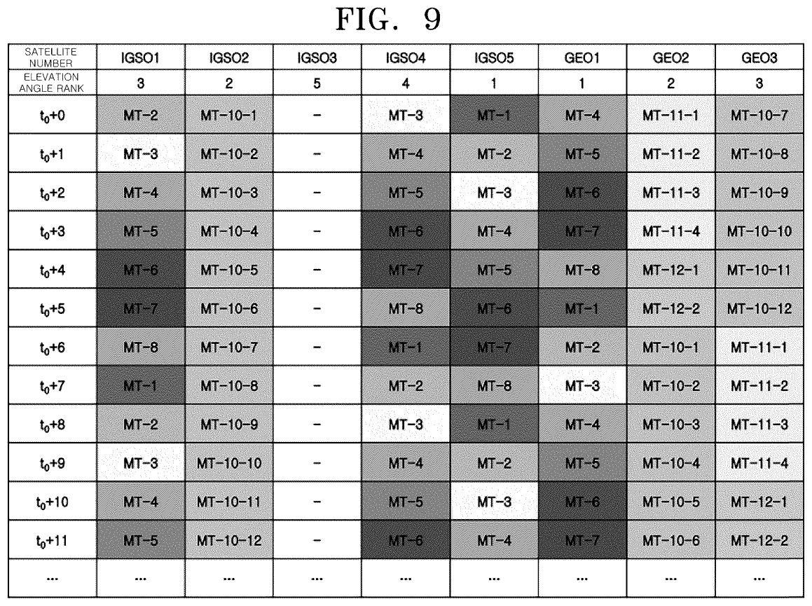

An embodiment of correction messages to be scheduled by the message scheduling unit 230 is shown in FIG. 4, and an embodiment of message transmission schedule information using multiple satellites generated by the message scheduling unit 230 is shown in FIGS. 8 and 9. The message scheduling unit 230 divides message scheduling sections based on a time point at which a set of satellites with high elevation angles changes and generates message transmission schedule information.

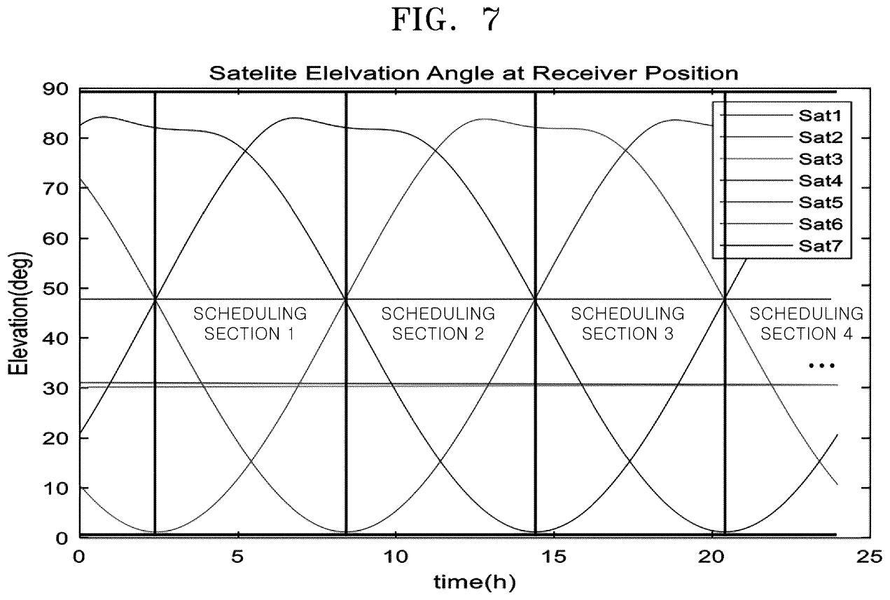

For example, when there are a total of 8 multiple satellites, the message scheduling unit 230 may sort the 8 multiple satellites in order of elevation angle and divide message scheduling sections based on a time point at which two satellites with the highest elevation angles change, that is, a time point at which satellites with the highest elevation angle variation from satellites 1 and 2 to satellites 2 and 3. An embodiment of scheduling section division is shown in FIG. 7.

The message generation unit 240 is a device that generates message frames for actual transmission to satellites. The message generation unit 240 generates message transmission frames according to message types to be transmitted to each of the multiple satellites according to message transmission schedule information. The configuration and content of data to be transmitted to satellites differs by message type. The message transmission frame data is delivered to the satellite-specific message transmission unit 260 by the message distribution unit 250.

The message distribution unit 250 is a device that distributes messages over time to each of the multiple satellites based on the generated message transmission schedule. The message distribution unit 250 selects messages to be transmitted to respective multiple satellites according to the generated message transmission schedule information and delivers the message transmission frames generated by the message generation unit 240 to the satellite-specific message transmission unit 260.

The satellite-specific message transmission unit 260 is a device that transmits the distributed message frames to respective satellites. The satellite-specific message transmission unit 260 serves to transmit message transmission frame data that is to be transmitted to each of the multiple satellites to the corresponding satellite through the uplink station. The correction messages transmitted to the multiple satellites as described above are provided to users through the satellites, and users may calculate corrected positions after receiving all message types transmitted by the multiple satellites.

Therefore, message transmission needs to be scheduled such that users may receive all message types as rapidly as possible to improve a Time To First Fix (TTFF), and message transmission needs to be scheduled such that users do not miss messages and may accurately correct their positions by considering satellite positions and user reception environments.

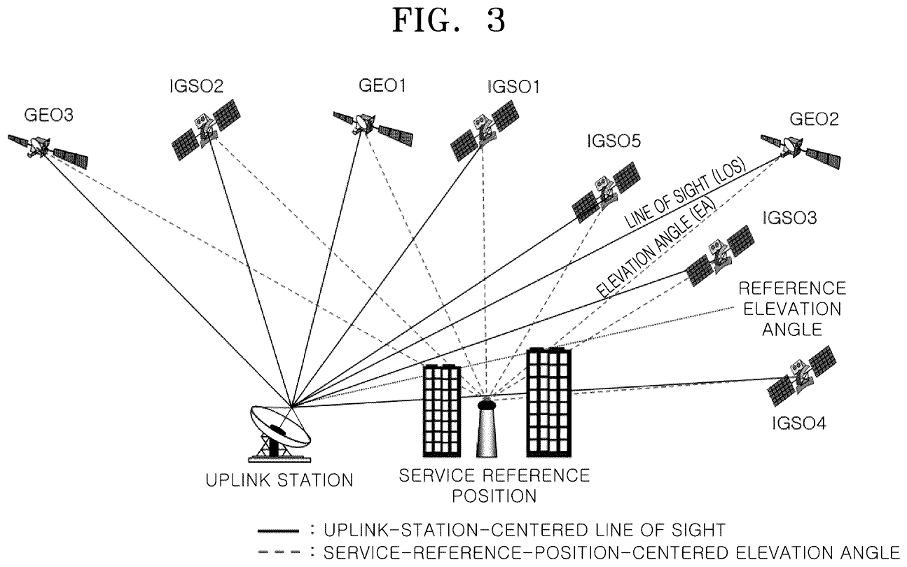

FIG. 3 shows a method of determining satellite lines of sight and elevation angles based on different reference points according to the present invention.

Referring to FIG. 3, the line of sight and elevation angle of each satellite are calculated by the satellite line-of-sight/elevation angle calculation unit 220 shown in FIG. 2. In a multiple satellite group including five IGSO satellites and three GEO satellites, a total of eight multiple satellites, satellites with elevation angles higher than a reference elevation angle based on the uplink station position are seven satellites other than IGSO satellite 4, and therefore the seven satellites have lines of sight and may transmit messages. In this case, the uplink station is not limited to a single uplink station and may be a plurality of uplink stations to be distributed in different regions.

Elevation angles are not calculated based on the uplink station but based on a main service reference position. However, in this case, the elevation angle may be calculated by setting the service reference position to the same position as the uplink station. The service reference position may be an urban area with many tall buildings as shown in FIG. 3, and assigning messages based on satellites IGSO1, IGSO5, and GEO1, which have the highest elevation angles at that position, may be a method of increasing a message reception rate.

FIG. 4 is a diagram illustrating an embodiment of a multiple satellite correction message block served according to the present invention.

Referring to FIG. 4, a single block message represents message types in which messages of the same type form a single block, and a multiple block message represent message types in which messages of the same type form multiple blocks.

For example, the single block message is a message format that requires reception once per second to receive all data of the message types, but the multiple block message is a message format that requires continuous reception over several seconds to receive all data of the message types.

In FIG. 4, MT-10 needs to be received over 12 seconds to receive all data. Therefore, for multiple block messages, it is required to schedule message transmission such that the multiple block message may be received continuously when satellite signal reception is available.

The apparatus described above may be implemented as a combination of hardware components, software components, and/or hardware components and software components. For example, the devices and components described in the embodiments may be implemented using one or more general-purpose computers or special-purpose computers, such as processors, controllers, arithmetic logic units (ALUs), digital signal processors, microcomputers, field programmable arrays (FPAs), programmable logic units (PLUs), microprocessors, or any other device capable of executing and responding to instructions. The processing device may execute an operating system (OS) and one or more software applications running on the operating system. The processing device may also access, store, manipulate, process, and generate data in response to software execution. For convenience of understanding, there may be cases in which one processing device is described as being used, but those skilled in the art will understand that the processing device may include multiple processing elements and/or multiple types of processing elements. For example, the processing device may include multiple processors or one processor and one controller. In addition, other processing configurations, such as parallel processors, are possible.

Software may include computer programs, code, instructions, or combinations of one or more of these, and may configure the processing device to operate as desired or command the processing device independently or collectively. Software and/or data may be permanently or temporarily embodied in any type of machine, component, physical device, virtual equipment, computer storage medium or device, or transmitted signal waves to be interpreted by the processing device or to provide instructions or data to the processing device. Software may be distributed over networked computer systems and stored or executed in a distributed manner. Software and data may be stored in one or more computer-readable recording media.

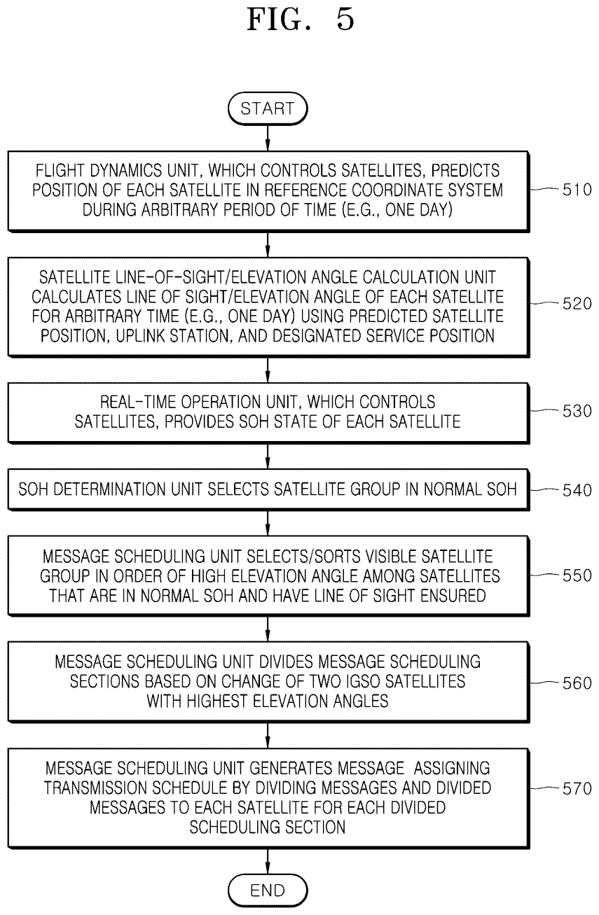

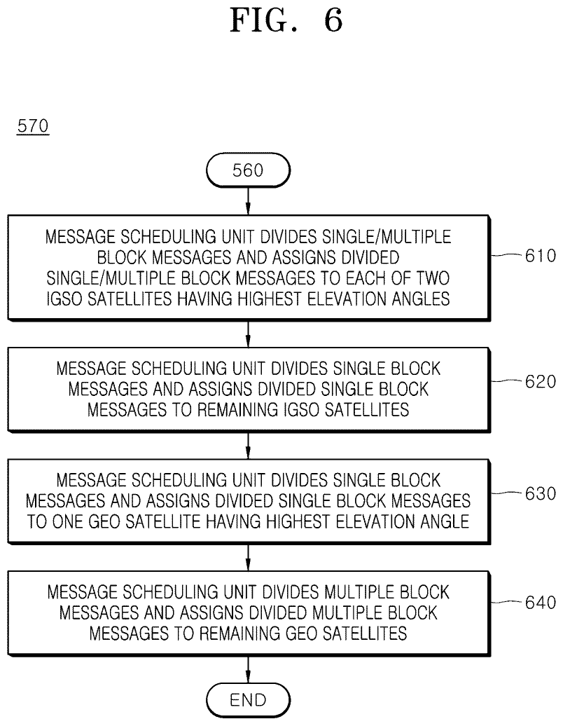

FIGS. 5 and 6 are flowcharts for describing a method of scheduling transmission of satellite navigation correction messages using multiple satellites according to an embodiment of the present invention.

The method of scheduling transmission of satellite navigation correction messages using multiple satellites is only one embodiment of the present invention, various additional operations may be included as needed, and the operations described below may be performed in a different order. Therefore, the present invention is not limited to the operations and the order of operations described below.

First, referring to FIGS. 2 and 5, in operation 510, the flight dynamics unit 103, which is a component device of the satellite control system 101, predicts the position of each of the multiple satellites during an arbitrary period of time. In this case, the flight dynamics unit 103 predicts how the orbital position of the satellite changes during an arbitrary period of time, for example during one day.

Next, in operation 520, the satellite line-of-sight/elevation angle calculation unit 220 uses the predicted result to calculate changes in the uplink station line of sight and changes in the elevation angle at a specific service position according to the position of the satellite.

Next, in operation 530, the real-time operation unit 102, which is a component device of the satellite control system 101, extracts telemetry for determining the health status of the satellite among telemetry data acquired from each satellite and provides the extracted telemetry to the satellite SOH determination unit 210.

Next, in operation 540, the SOH determination unit 210 determines the normal state of each of the multiple satellites using the acquired information and distinguishes satellites in a normal operating state. The process of calculating the line of sight and the elevation angle through the flight dynamics unit 103 (operation 520) and the process of determining the health status of the satellite through the real-time operation unit 102 (operation 530) may be performed in reverse order or processed in parallel.

Next, in operation 550, the message scheduling unit 230 uses the satellite-specific normal state information and the satellite-specific line-of-sight and elevation angle information to select a group of visible satellites in order of high elevation angle at the service position among satellites that are in a normal state and have a line of sight with the uplink station.

Next, in operation 560, the message scheduling unit 230 divides message scheduling sections based on a section in which two IGSO satellites with the highest elevation angles change. A detailed method of dividing scheduling sections is shown in FIG. 7.

Next, in operation 570, the message scheduling unit 230 generates message transmission schedule information by assigning message types to be transmitted to each satellite for each of the divided scheduling sections. Operation 570 is repeatedly performed until generation of the message transmission schedule information has been completed for all divided scheduling sections.

Referring to FIG. 6 for more specific details about this:

First, in operation 610, the message scheduling unit 230 assigns schedules of single block messages and multiple block messages based on two IGSO satellites with high elevation angles.

Next, in operation 620, the message scheduling unit 230 assigns single block messages to the remaining visible IGSO satellites. Through this process, the message scheduling unit 230 may increase the probability that correction messages (message transmission schedule information) may be rapidly received even in service areas in which it is difficult to secure a sufficient number of visible satellites, such as clusters of high-rise buildings.

Next, in operation 630, the message scheduling unit 230 performs message scheduling on GEO satellites and assigns single block messages to GEO satellites with the highest elevation angle. Since the elevation angle of GEO satellites does not change at a specific service position, the message scheduling unit 230 may improve user correction accuracy by continuously providing single block messages, which have short update cycles, through high-elevation GEO satellites.

Next, in operation 640, the message scheduling unit 230 assigns multiple block messages to the remaining GEO satellites. GEO satellites are capable of continuous transmission once visibility is ensured and are therefore advantageous for receiving messages that take time to receive.

As described above, the message scheduling unit 230 appropriately divides and assigns single block messages and multiple block messages to IGSO satellites and GEO satellites and broadcasts the messages to users, thereby maximizing the probability that users may receive correction messages even in environments in which reception is difficult, and the message scheduling unit 230 has users receive correction messages divided among multiple satellites, thereby allowing users to rapidly receive a plurality of messages and correct their positions. The results of message transmission scheduling are shown in FIGS. 8 and 9.

FIG. 7 is a diagram illustrating an embodiment in which correction message scheduling sections are divided based on changes in satellites having high elevation angles according to the present invention.

The graph in FIG. 7 shows changes in elevation angles over time for multiple satellites, in which Sat1 to Sat3 are elevation angles of GEO satellites and have constant elevation angles, and Sat4 to Sat7 are elevation angles of IGSO satellites whose elevation angle sizes change over time.

In scheduling section 1, Sat4 and Sat7 have the highest elevation angles, scheduling section 2 is a section in which Sat6 and Sat7 have the highest elevation angles, and scheduling section 3 is a section in which Sat5 and Sat6 have the highest elevation angles. Thus, the scheduling sections may be divided based on the elevation angles of IGSO satellites.

FIG. 8 is a diagram illustrating an embodiment in which message types are assigned over time through message scheduling for each satellite for correction message services using multiple satellites according to the present invention.

Referring to FIGS. 2 and 8, in assigning messages to IGSO satellites, the message scheduling unit 230 is configured to assign single block messages and multiple block messages individually to IGSO1 and IGSO5 satellites, which rank first in elevation angle among IGSO satellites, and is configured to assign single block messages to the remaining IGSO satellites. In assigning messages to GEO satellites, the message scheduling unit 230 is configured to assign single block messages to GEO1 satellite, which ranks first in elevation angle among GEO satellites, and is configured to assign multiple block messages to the remaining GEO satellites.

Here, for satellites selected to be assigned single block messages, the message scheduling unit 230 assigns the messages according to a single block message sequence shown in FIG. 4, but assigns the messages such that different message types start at the same time point, which enables a user to receive all correction messages more rapidly when the user is in an environment in which reception from multiple satellites is possible, for example, when IGSO1, IGSO2, IGSO3, and GEO1 are satellites selected to be assigned single block messages, the message scheduling unit 230 assigns schedules for IGSO1 to perform transmission starting from MT-1, IGSO2 from MT-2 single block message, IGSO3 from MT-3 single block message, and GEO1 from MT-4 single block message.

Similarly, for satellites selected to be assigned multiple block messages, the message scheduling unit 230 assigns the messages according to a multiple block message sequence shown in FIG. 4 but may assign the messages to enable start based on the number of message types or the number of sub-messages constituting the multiple blocks at the same time point. For example, when IGSO5, GEO2, and GEO3 are satellites selected to be assigned multiple block messages, the message scheduling unit 230 assigns schedules for IGSO5 to start transmitting from MT-10-1 multiple block message, GEO2 from MT-11-1 multiple block message, and GEO3 from MT-10-7 multiple block message.

When assigning multiple block messages, the message scheduling unit 230 needs to divide each message type such that all blocks may be received in as short a time as possible, based on the message type having the largest number of multiple blocks, thereby minimizing reception time. In this case, both the satellites transmitting the single-block messages and the satellites transmitting the multi-block messages sequentially transmit their respective message sequences.

That is, for single block message transmission, satellites starting from MT-1 subsequently transmit in the order of MT-2 and MT-3, and after transmitting all single block messages, repeat transmission from MT-1 again. For multiple block message transmission, satellites starting from MT-10-1 subsequently transmit MT-10-2, MT-10-3 . . . , MT-11-1, MT-11-2 . . . , MT-12-1, and MT-12-2, and after transmitting all multiple block messages, repeat transmission from MT-10-1 again.

FIG. 9 is a diagram illustrating an embodiment of message schedules that change for each satellite when the scheduling section changes due to a change in satellites having high elevation angles according to the present invention.

Referring to FIG. 9, as the configuration of two IGSO satellites having high elevation angles changes, the assignment of single block messages and multiple block messages also changes. However, in present embodiment, the messages are arranged such that different message types are assigned at the same time, thereby enabling simultaneous reception of multiple types of messages.

As described above, even users located in service areas with poor reception environments may be provided with a more advantageous correction-message service in which both the single-block messages and the multi-block messages may be provided from two satellites having the highest elevation angles.

As is apparent from the above, according to the present invention, when multiple types of messages are transmitted to users in providing satellite navigation correction services, messages can be transmitted rapidly, thereby reducing the time taken for initial position acquisition.

According to the present invention, since correction messages are transmitted using some satellites with high visibility in service areas in which visibility is difficult to secure, the correction service can be provided with more stable correction services by increasing a message reception rate.

According to the present invention, since inclined geosynchronous orbit (IGSO) satellites, which are numerous, are used as satellites serving single block messages, even when some satellites are not visible, correction messages can be rapidly acquired from other satellites.

According to the present invention, since GEO satellites without elevation angle variations are used as satellites serving multiple block messages, multiple messages can be continuously received without being missing.

According to the present invention, since a single IGSO satellite and a single GEO satellite are allowed to serve multiple block messages and single block messages, respectively, and perform complementary roles, continuity of service can be maximized.

According to the present invention, since a plurality of satellites are used for correction message transmission, correction messages for ensuring positioning accuracy can be transmitted more rapidly, and the remaining message space can be utilized to provide application message services for additional services such as disaster relief information, weather information, and public broadcasting.

Although the present invention has been described with reference to embodiments illustrated in the drawings, the embodiments disclosed above should be construed as being illustrative rather than limiting the present invention, and those skilled in the art should appreciate that various substitutions, modifications, and changes are possible without departing from the scope and spirit of the present invention. Therefore, the scope of the present invention is defined by the appended claims of the present invention.

What is claimed is:

1. An apparatus for scheduling transmission of satellite navigation correction messages using multiple satellites, the apparatus comprising:
a communication unit; and
a processor that receives position prediction information of each satellite from a satellite control system through the communication unit, calculates a line of sight and an elevation angle of each of the satellites based on the position prediction information, and generates message transmission schedule information for transmitting a satellite navigation correction message by considering the calculated line of sight and the calculated elevation angle.

2. The apparatus of claim 1, wherein the processor is configured to:
calculate a line of sight of each of the satellites based on the position prediction information and position information of an uplink station; and
calculate an elevation angle of each of the satellites based on the position prediction information and service reference position information.

3. The apparatus of claim 2, wherein the processor is configured to:
calculate an elevation angle of each satellite for which a lines of sight is ensured from the uplink station, based on the calculated line of sight of each of the satellites; and
generate the message transmission schedule information based on the calculated elevation angle.

4. The apparatus of claim 1, wherein the satellite control system is configured to:
generate the position prediction information that estimates in-orbit positional changes of each of the satellites using data required for orbit prediction of each of the satellites among telemetry data transmitted by each of the satellites; and
transmit the position prediction information to the processor through the communication unit.

5. The apparatus of claim 1, wherein the processor is configured to:
receive state of health (SOH) information of each of the satellites from the satellite control system through the communication unit; and
generate the message transmission schedule information by further considering the SOH information together with the calculated line of sight and the calculated elevation angle.

6. The apparatus of claim 5, wherein the processor is configured to:
select a satellite group having a normal SOH based on the SOH information; and
generate the message transmission schedule information by comparing the calculated elevation angles of satellites for which lines of sight are ensured among the selected satellite group.

7. The apparatus of claim 6, wherein the processor is configured to:
select and sort a group of visible satellites in order of high elevation angle among the satellites for which lines of sight are ensured according to a result of the comparison;
divide message scheduling sections based on a time point at which N (N is a natural number of 2 or more) satellites having the highest elevation angles in the group of the visible satellites change; and
generate the message transmission schedule information by dividing messages and assigning the divided messages to the satellites for each of the divided message scheduling sections.

8. The apparatus of claim 7, wherein the processor is configured to:
divide single block messages and multiple block messages and assign the divided single block messages and the divided multiple block messages to each of N inclined geosynchronous orbit (IGSO) satellites having the highest elevation angles; and
divide single block messages and assign the divided single block messages to IGSO satellites excluding the N IGSO satellites.

9. The apparatus of claim 7, wherein the processor is configured to:
divide single block messages and assign the divided single block messages to M (M is a natural number of 1 or more) geostationary earth orbit (GEO) satellites having the highest elevation angle; and
divide multiple block messages and assign the divided multiple block messages to GEO satellites excluding the M GEO satellites.

10. The apparatus of claim 5, wherein the satellite control system is configured to:
generate the SOH information on determining a health status of each of the satellites using data required for determining a health status of each of the satellites among telemetry data transmitted by each of the satellites; and
transmit the SOH information to the processor through the communication unit.

11. A method of scheduling transmission of satellite navigation correction messages using multiple satellites, the method comprising:
receiving, by a processor, position prediction information of each satellite from a satellite control system through a communication unit;
calculating, by the processor, a line of sight and an elevation angle of each of the satellites based on the position prediction information; and
generating, by the processor, message transmission schedule information for transmitting a satellite navigation correction message by considering the calculated line of sight and the calculated elevation angle.

12. The method of claim 11, wherein the calculating of the line of sight and the elevation angle of each of the satellites includes:
calculating a line of sight of each of the satellites based on the position prediction information and position information of an uplink station; and
calculating an elevation angle of each of the satellites based on the position prediction information and service reference position information.

13. The method of claim 12, wherein the calculating of the elevation angle of each of the satellites includes:
calculating an elevation angle of each satellite for which a line of sight is ensured from the uplink station, based on the calculated line of sight of each of the satellites; and
generating the message transmission schedule information based on the calculated elevation angle.

14. The method of claim 11, further comprising:
generating the position prediction information on estimation of in-orbit positional changes of each of the satellites using data required for orbit prediction of each of the satellites among telemetry data transmitted by each of the satellites; and
transmitting the position prediction information to the processor through the communication unit.

15. The method of claim 11, further comprising receiving, by the processor, state of health (SOH) information of each of the satellites from a satellite control system through the communication unit,
wherein the generating of the message transmission schedule information includes generating the message transmission schedule information by further considering the SOH information together with the calculated line of sight and the calculated elevation angle.

16. The method of claim 15, wherein the generating of the message transmission schedule information includes:
selecting a satellite group having a normal SOH based on the SOH information; and
generating the message transmission schedule information by comparing the calculated elevation angles of satellites for which lines of sight are ensured among the selected satellite group.

17. The method of claim 16, wherein the generating of the message transmission schedule information by comparing the calculated elevation angles includes:
selecting and sorting a group of visible satellites in order of high elevation angle among the satellites for which lines of sight are ensured according to a result of the comparison;
dividing message scheduling sections based on a time point at which N (N is a natural number of 2 or more) satellites having the highest elevation angles in the group of the visible satellites change; and
generating the message transmission schedule information by dividing messages and assigning the divided messages to the satellites for each of the divided message scheduling sections.

18. The method of claim 17, wherein the generating of the message transmission schedule information by dividing messages and assigning the divided messages to the satellites includes:
dividing single block messages and multiple block messages and assigning the divided single block messages and the divided multiple block messages to each of N inclined geosynchronous orbit (IGSO) satellites having the highest elevation angles; and
dividing single block messages and assigning the divided single block messages to IGSO satellites excluding the N IGSO satellites.

19. The method of claim 17, wherein the generating of the message transmission schedule information by dividing messages and assigning the divided messages to the satellites includes:
dividing single block messages and assigning the divided single block messages to M (M is a natural number of 1 or more) geostationary earth orbit (GEO) satellites having the highest elevation angles; and
dividing multiple block messages and assigning the divided multiple block messages to GEO satellites excluding the M GEO satellites.

20. The method of claim 15, further comprising:
generating, by the satellite control system, the SOH information on determining a health status of each of the satellites using data required for determining a health status of each of the satellites among telemetry data transmitted by each of the satellites; and
transmitting, by the satellite control system, the SOH information to the processor through the communication unit.
